(19) United States
(12) Patent Application Publication
(10) Pub. No.: US 2018/0208092 A1
(43) Pub. Date: Jul. 26, 2018

(54) FASTENING DEVICE FOR FASTENING A SEAT COVER

(71) Applicant: Ford Global Technologies, LLC, Dearborn, MI (US)

(72) Inventor: Joerg Stephan, Pulheim (DE)

(73) Assignee: Ford Global Technologies, LLC, Dearborn, MI (US)

(21) Appl. No.: 15/859,832

(22) Filed: Jan. 2, 2018

(30) Foreign Application Priority Data
Jan. 20, 2017 (DE) 102017200946.2

(51) Int. Cl. B60N 2/60; A47C 31/11; A47C 7/62; F16B 12/26; F16B 12/24

(52) U.S. Cl. CPC B60N 2/6027; A47C 31/11; B60N 2/6009; F16B 12/26; F16B 12/24; A47C 7/386

(57) ABSTRACT

A fastening device for fastening at least a part of a seat cover of a seat. The fastening device comprises a first holding unit arranged on a surface, which faces a seat user, of the seat cover, and a second holding unit which can be arranged on a counter-surface which is opposite the surface. The first holding unit has at least one fastening element and the second holding unit has at least one corresponding fastening element for mechanical connection of the holding units, and the second holding unit has a fastening unit for production of a mechanical connection to the seat.

### FIELD OF THE INVENTION

The present invention generally relates to a seat cover fastening device, and more particularly relates to a fastening device for fastening at least a part of a seat cover of a seat.

### BACKGROUND OF THE INVENTION

Seats, in particular vehicle seats, also have, in addition to carrying structural components to support a seated person, cushions to provide seating comfort for the seated person. The cushions can be formed, for example, by shaped plastic foam elements. Seat covers which are manufactured, for example, from a textile material or from leather serve to cover the cushioning means towards the outside, in particular in relation to the seated person. The seat covers should, where possible, not be displaced relative to the structural components as result of a use of the seat. The possibility of simple mounting or replacement is also desirable for simplified production of a seat and because the structural components of the seat generally have a longer life span than the seat cover.

Fasteners which can be fixedly connected to flexible materials such as, for example, textile substances and with the help of which flexible material can be fitted with fasteners are generally known from the prior art.

For example, a two-part clamping device for binding a strip of a flexible material is described in U.S. Pat. No. 7,406,753 B2. The clamping device comprises a first longitudinally extended, triple conically tapering wedge element which can be inserted into a corresponding, triple conically tapering groove. The two components are bound to the covering material arranged between them by means of frictionally engaged clamping and compress a relatively large surface of a material which can be composed in particular from a plastic material with an installed reinforcing fiber lattice. The clamping device is then bound to a large number of horizontally and vertically arranged reinforcing elements of the plastic covering film in a frictionally engaged clamping in order to achieve reliable holding and an easily detachable binding without damaging the material. One of the components has a fastening means in the form of an integrated eye to which the plastic covering film can be secured with a cord.

A further solution for an easily detachable binding to a leaf-like, flexible object by means of a clamp is described in JP 2012-247487 A. The clamp contains a pair of holding elements on which holding surfaces for holding the leaf-like object are formed. One of the holding elements has a wedge element which extends in one surface direction of the holding surface and is expanded into a body. The other holding element is provided with an elevated insertion frame into which the wedge element of the counter-holding element can be inserted with a holding surface side. A surface opposite the holding surface side of the wedge element has an oblique design so that a base part side is designed to be thick and a peak side is designed to be thinner and the wedge element part is pressed into the insertion frame, against the other holding element with the insertion frame. As a result, the object is held between the two holding elements.

Fastening components for fastening a seat cover to a cushioning means have generally been proposed in the prior art. A seat component is proposed, for example, in U.S. Patent Application Publication No. 2007/0035165 A1, which seat component comprises a cushion, a cover with at least one seam and a one-piece cover fastening element for fastening of the cover to the cushion. The cover fastening element comprises a first end which is connected to the cover seam and a second end which extends at least into a part of the cushion and is fastened thereto. The cover fastening element can be formed, for example, from a thermoplastic polymer. The first end of the cover fastening element is arranged in the vicinity of the first side, facing a seated person, of the cushion. The second end of the cover fastening element is arranged in the vicinity of a second side, spaced apart from the first side, of the cushion, which side faces away from the seated person.

It would be desirable to provide a fastening device for fastening seat covers which can be easily mounted and effectively prevents a displacement of the seat cover relative to a carrying structure of the seat as a result of a use of the seat.

### SUMMARY OF THE INVENTION

According to one aspect of the present invention, a fastening device for fastening at least a part of a seat cover of a seat is provided. The fastening device includes a first holding unit arranged on a first surface, which faces a seat user, of the seat cover. The fastening device also includes a second holding unit arranged on a counter second surface which is opposite the first surface, wherein the first holding unit has at least one first fastening element and the second holding unit has at least one corresponding second fastening element for mechanical connection of the first and second holding units, and the second holding unit has a fastening unit for mechanical connection to the seat.

According to another aspect of the present invention, a fastening device for fastening a seat cover is provided. The fastening devices includes a first holding unit arranged on an outer surface of the seat cover and having a first fastening element, and a second holding unit arranged on an inner surface of the seat cover and having a corresponding second fastening element for mechanical connection with the first fastening element, wherein the second holding unit has a fastening unit for mechanical connection to the seat.

According to a yet another aspect of the present invention, a seat is provided. The seat includes a seat structure for support of a part of a seated person, a seat cover for at least partial covering of the seat structure, and a fastening device for fastening the seat cover on the seat structure. The seat structure includes a first holding unit arranged on a first surface, which faces a seat user, of the seat cover, and a second holding unit arranged on a counter second surface which is opposite the first surface, wherein the first holding unit has at least one first fastening element and the second holding unit has at least one corresponding second fastening element for mechanical connection of the first and second holding units, and the second holding unit has a fastening unit for mechanical connection to the seat structure.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a top perspective view of a vehicle seat with two installed fastening devices according to one embodiment;

FIG. 2 is an exploded perspective view of the embodiment of the fastening device shown in FIG. 1; and

FIG. 3 is a schematic, sectional side view of the fastening device shown in FIG. 2.

### DETAILED DESCRIPTION OF THE PREFERRED EMBODIMENTS

Identical parts are always provided with the same reference numbers in the various figures, which is why they are also generally only described once.

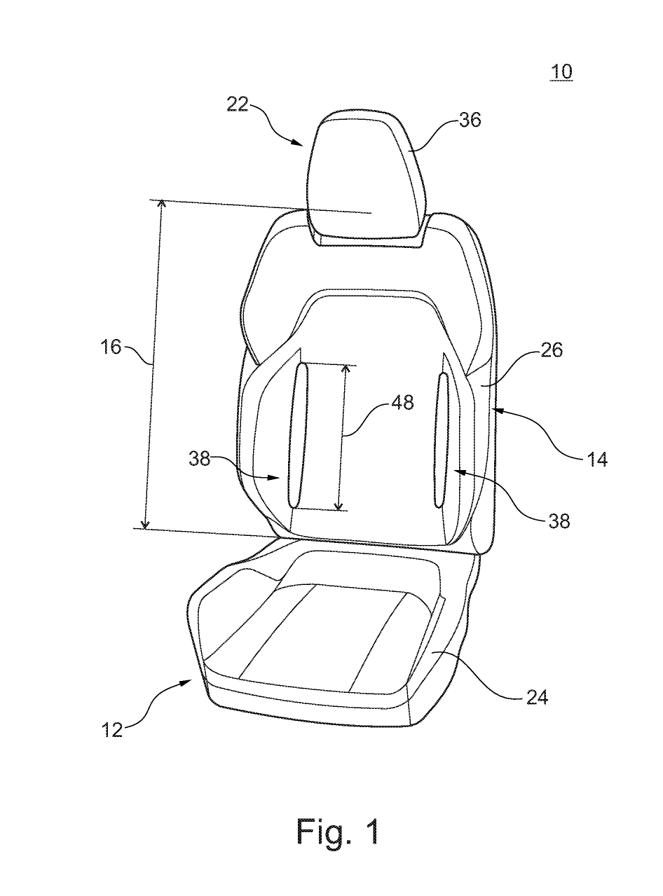

FIG. 1 shows a seat 10, which is formed as a vehicle seat and, in particular, as a front seat of a car, with two installed fastening devices 38 according to one embodiment in a 3D top perspective view. The seat 10 contains a functional component which is formed as a seat base structure 12 and serves to support a lower part of a seated person. A further functional component of seat 10 is formed by a backrest structure 14 which serves to support an upper part of the seated person. The seat 10 furthermore has a functional component which is formed as a headrest structure 22 and which is adjustable in terms of its height in a manner known per se. The seat 10 can also represent further functional components which are formed, for example, by armrest structures and which are, however, not represented in FIG. 1.

The seat 10 has a plurality of seat covers 24, 26, 36 for covering functional components and a plurality of fastening devices 38 according to the one embodiment for fastening seat covers of the plurality of seat covers 24, 26, 36. Two fastening devices 38 according to one embodiment which serve to fasten seat cover 26 for covering backrest structure 14 are shown by way of example in FIG. 1.

The seat 10 further comprises cushion elements for cushioning seat base structure 12, of backrest structure 14 and of headrest structure 22 which are covered by seat covers 24, 26, 36 and are not visible in FIG. 1.

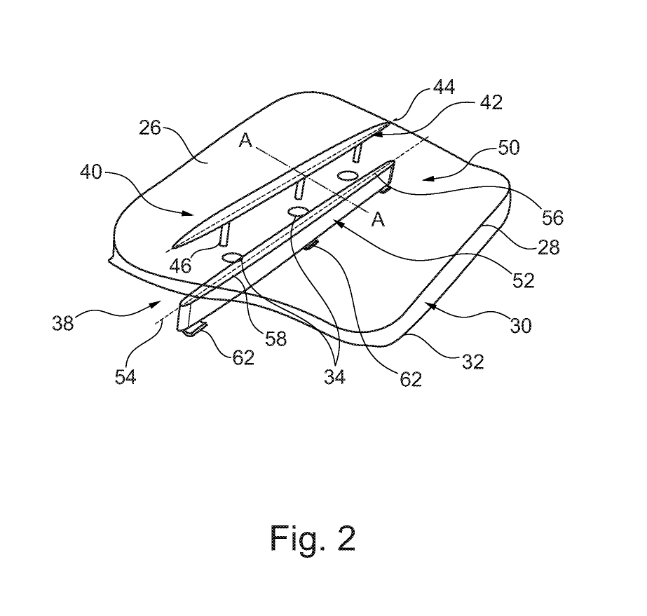

FIG. 2 shows one of fastening devices 38 according to one embodiment according to FIG. 1 in a schematic 3D exploded perspective representation. Since both fastening devices 38 have an identical structure, it is sufficient at this point to describe their structure on the basis of one of the two fastening devices 38.

The seat cover 26 for covering backrest structure 14 contains an outer decorative cover part 28 facing the seat user, a thin cushion layer 30 lying thereunder and facing away from the seat user as well as a textile cover part 32 arranged under cushion layer 30 and connected to decorative cover part 28 on the outside.

Fastening device 38 comprises a first holding unit 40 which is arranged on a first or outer surface, which faces a seat user, of seat cover 26, for covering backrest structure 14, namely decorative cover part 28. First holding unit 40 has a longitudinally formed base body 42 with a center line 44 which is formed to conically taper at both ends. First holding unit 40 is fitted with a plurality of three first fastening elements 46 which are formed identically as pins and are arranged spaced apart evenly from one another on an under side, which faces seat cover 26, of first base body 42 of first holding unit 40 and extend perpendicular to the underside of first base body 42. The first base body 42 and first fastening elements 46 of first holding unit 40 may be produced entirely, i.e., by 100%, from an exemplary thermoplastic plastic material, e.g., from acrylonitrile-butadiene-styrene (ABS), wherein fastening elements 46 and base body 42 of first holding unit 40 may be produced, for example, in one piece by means of an injection molding process, according to one embodiment.

The first surface, which is visible in an installation state of fastening device 38, of base body 42 of first holding unit 40 can be embodied in various ways and have, for example, a structured surface and/or be metallized or coated.

Fastening device 38 further contains a second holding unit 50 which is arranged on a counter-second or inner surface opposite the first surface of seat cover 26, i.e., decorative cover part 28, namely on textile cover part 32. Second holding unit 50 has a second longitudinally formed base body 52 with a center line 54 and is fitted on an end side 58 facing textile cover part 32 with a plurality of three second fastening elements 56 which are formed identically as through-holes 34 arranged perpendicular to end side 58. The second base body 52 of second holding unit 50 may be produced entirely, i.e., by 100%, by means of an injection molding process from ABS in this embodiment.

The plurality of second fastening elements 56 of second holding unit 50 correspond to the plurality of first fastening elements 46 of first holding unit 40 in that a diameter of the through-holes is adapted to a diameter of the pins and in that the through-holes in base body 52 of second holding unit 50 are evenly spaced apart in the same manner as the pins on the underside of base body 42 of first holding unit 40.

The first fastening elements 46 of first holding unit 40 and second fastening elements 56 of second holding unit 50 serve the purpose of mutual mechanical connection of holding units 40, 50. In the installation state of fastening device 38, the pins are introduced and glued on the underside of base body 42 of first holding unit 40 in the through-holes in end side 58 of base body 52 of second holding unit 50 so that the mechanical connection between first holding unit 40 and second holding unit 50 is brought about by adhesive bond between fastening elements 46 and base body 52. Introduction of the pins into the through-holes is carried out through three prefabricated continuous openings 34 in seat cover 26 for covering backrest structure 14.

Alternatively, the connection can be produced by an adhesive bond between first holding unit 40 and second holding unit 50 and/or also by friction welding, for example, by ultrasound welding.

In another embodiment, the connection between first holding unit 40 and second holding unit 50 can also be produced by a spring clamp connection (clip connection). To this end, the fastening element of first holding unit 40 and the fastening elements of second holding unit 50 must be formed in a suitable manner known to the person skilled in the art.

In the installation state of fastening device 38, center line 44 of base body 42 of first holding unit 40 and center line 54 of base body 52 of second holding unit 50 are arranged on the first surface, which faces a seat user, of seat cover 26, i.e., decorative cover part 28, and the counter-second surface, which is opposite decorative cover part 28, i.e., on textile cover part 32, are arranged parallel to one another.

The pins on the underside of base body 42 of first holding unit 40 are, prior to gluing, introduced into the through-holes in end side 58 of base body 52 of second holding unit 50 so far that, after the production of the adhesive bond by the mechanical connection of holding units 40, 50, a force acts between the first surface facing a seat user (decorative cover part 28) and the counter-second surface opposite the first surface (textile cover part 32) of seat cover 26. As a result of this arrangement, decorative cover part 28 is deformed in a desired manner in order to be adapted to the first surface which faces the seat user and is ergonomically configured.

As can be inferred from FIG. 1, a maximum dimension 48 of base body 42 of first holding unit 40 in a direction of extent formed by center line 44 is at least 20%, namely approximately 44%, of a dimension 16, determined in the direction of extent, of backrest structure 14 to which first holding unit 40 is attached.

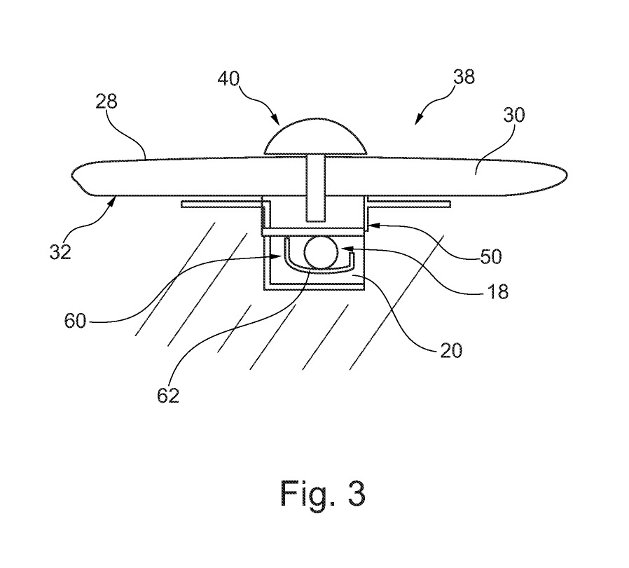

Seat 10 is fitted with a plurality of seat cover fastening devices 18 which may be configured as shown in FIG. 3, according to one embodiment. Seat cover fastening device 18 may be formed as plastic wire. The functional component formed as a backrest structure 14 is provided with two plastic wires, of which respectively one is arranged in a substantially perpendicular direction in a duct 20 in a cushion element of backrest structure 14 and with both ends is fixedly connected to backrest structure 14 (not represented).

Second holding unit 50 has, on a side opposite end side 58 of base body 52, a fastening unit 60 for the production of a mechanical connection to seat 10. Fastening unit 60 comprises a plurality of three openly formed hook elements 62 which are arranged spaced apart from one another in the direction of center line 54 of base body 52 (FIG. 2). Base body 52 of second holding unit 50 and the plurality of hook elements 62 may be formed in one piece from ABS by means of the injection molding process.

In order to produce the installation state represented in FIG. 3 of fastening device 38, openly formed hook elements 62 of fastening unit 60 are provided to arrive at the production of the mechanical connection to seat 10 in engagement with seat cover fastening device 18 of seat 10.

A diameter of the plastic wires and a diameter of upwardly open hook elements 62 are adapted to one another. As a result of the elastic properties of the plastic material, a restoring spring force can be generated by deformation of hook elements 62. For installation of fastening device 38 in seat 10, three hook elements 62 are pushed laterally against the plastic wire until an opening of each of hook elements 62 is sufficient in order to push relevant hook element 62 laterally onto the plastic wire. As a result, fastening unit 60 and the plastic wire form a detachably fixed mechanical connection which is produced after overcoming a predetermined spring force by means of a combination of positive locking and non-positive locking. The mechanical connection is reversible so that seat cover 26 can be removed by detaching the connection in a simple manner in order, for example, to replace seat cover 26 of back rest structure 14.

It is pointed out here that the features and measures listed individually in the following description can be combined with one another in any desired, technically expedient manner and highlight further configurations of the invention. The description additionally characterizes and specifies embodiments of the invention in particular in conjunction with the figures.

The fastening device according to one embodiment for fastening at least a part of a seat cover of a seat has a first holding unit which can be arranged on a surface, which faces a seat user, of the seat cover, a second holding unit which can be arranged on a counter-surface which is opposite the surface.

The term “a counter-second surface which is opposite the first surface” should be understood within the meaning of this invention in particular in that the first surface, which faces the seat user, of the seat cover divides the chamber into a first and a second sub-chamber, wherein the seat user is located in the first sub-chamber and the counter-surface is arranged in the second sub-chamber.

The first holding unit has at least one fastening element and the second holding unit has at least one corresponding fastening element for mechanical connection of the holding units. The second holding unit has a fastening unit for production of a mechanical connection to the seat.

One advantage of the fastening device lies in the fact that a displacement of a part, fastened with the fastening device according to one embodiment, of a seat cover relative to a carrying structure of the seat can be effectively prevented. A prefabrication of parts of a seat cover of a seat is furthermore enabled by the disclosed concepts. Mounting of parts of a seat cover can be carried out in a simple manner by producing the mechanical connection to the seat.

A further advantage of the fastening device lies in the fact that, in one suitable design, parts of a seat cover can be easily replaced by detaching the mechanical connection to the seat.

The terms used in this application “first,” “second,” etc. only serve the purpose of differentiation. In particular, no sequence or priority of the objects stated in conjunction with these terms should be implied by their use.

The seat cover can contain, in addition to an outer decorative cover part which faces a seat user, a cushion layer which lies under it and faces away from the seat user. In this case, the counter-surface opposite the surface can be formed by a surface, facing away from the seat user, of the cushion layer or by a decorative or covering cover applied on the surface, facing away from the seat user, of the cushion layer.

The fastening device can advantageously be used in particular for fastening at least a part of a seat cover of a vehicle seat. The term “vehicle” should be understood within the meaning of this invention to include a car, a truck or a motorbus.

The mutual mechanical connection of the holding units by the seat cover can be formed by a prefabricated through-opening in the seat cover, for example, in the case of a seat cover made of leather. The mutual mechanical connection can also be formed by a through-opening in the seat cover generated by one of the fastening elements during mounting, for example, in the case of a seat cover with a textile surface.

In one embodiment of the fastening device, the mechanical connection between the first holding unit and the second holding unit is formed by adhesive bond with at least one of the fastening elements or by a spring clamp connection between the fastening elements.

A mechanical connection by adhesive bond can be brought about, for example, by gluing, welding or other suitable methods. A mechanical connection formed by spring clamp connection (clip connection) can be formed, for example, by overcoming a predetermined spring force by means of positive locking or a combination of positive locking and non-positive locking. Any spring clamp connection which appears to be suitable to the person skilled in the art can be used for this purpose.

As a result, an effective and reliable mechanical connection between the first holding unit and the second holding unit can be achieved in a simple manner.

In embodiments of the fastening device according to one embodiment, the mechanical connection of the fastening device to the seat is formed to be reversible.

In further possible embodiments of the fastening device, a securing means, for example, with a string or a wire, is expressly ruled out for the mechanical connection of the fastening device to the seat.

In one embodiment, a force is preferably active between the first surface which faces a seat user and the counter-second surface of the seat cover opposite the first surface as a result of the mechanical connection of the holding units. In one suitable design, by selection of the form of the holding units, a force can be exerted on the seat cover with which a desired deformation of the surface and/or the opposite counter-surface of the seat cover can be achieved if these surfaces of the seat cover, as generally normal, comprise flexible material. A “flexible” material is supposed to refer in particular to a material which, in a free-standing manner, cannot absorb any forces acting from the outside in a direction transverse to directions of its extent, such as, for example, a length of textile material.

It is furthermore proposed that the first and second holding unit respectively have a longitudinally formed base body, wherein the base bodies are provided in an installation state for a parallel arrangement on the surface of the seat cover facing a seat user and the counter-surface opposite the surface.

A “parallel arrangement” of the base bodies is supposed to be understood in particular in that a direction of extent of the first holding unit and a direction of extent of the second holding unit, for example, labelled by center lines, run parallel to one another. The term “provided to” is supposed to be understood in particular as specially configured or arranged for this purpose.

As a result of the parallel arrangement of the two base bodies, in one suitable embodiment, a particularly stable mechanical connection of the holding units and/or a uniform surface pressure on the surface, facing a seat user, of the seat cover and the opposite counter-surface and/or a desired deformation of the surfaces can be achieved without impairing a function of the seat cover.

In one advantageous embodiment of the fastening device, at least one of the holding units is primarily composed of a thermoplastic plastic material. The term “primarily” should in this application be understood in particular as a ratio of more than 50 vol. %, preferably of more than 70 vol. % and, particularly preferably, of more than 90 vol. %. In particular, the term should include the possibility that at least one of the holding units is composed entirely, i.e., by 100 vol. %, of the thermoplastic plastic material.

As a result, the production processes which are known for the processing of thermoplastic plastic materials such as, for example, injection molding, extrusion, etc. can be used, as a result of which a high dimensional stability, a one-piece nature of several components such as, for example, base body and fastening element and low units costs in the case of high unit numbers can be enabled.

The thermoplastic plastic can, for example, be selected from, but not restricted to, a group which is formed by acrylonitrile-butadiene-styrene (ABS), polypropylene (PP), polyoxymethylene (POM), polyethylene (PE), polyamides (PA), polymethylmethacrylate (PMMA), polyethersulfone (PES), polyphenylene sulphide (PPS) and a mixture of at least two of these plastic materials.

In one embodiment of the fastening device, the fastening unit has a plurality of openly formed hook elements. The hook elements are arranged in a manner spaced apart from one another in an installation state on a side of the base body of the second holding unit facing away from the base body of the first holding unit. The plurality of openly formed hook elements is provided to arrive at the production of the mechanical connection in the installation state to the seat in engagement with a seat cover fastening means of the seat. The term “plurality” should be understood to be a number of at least two. As a result, mounting of prefabricated parts of a seat cover can be carried out in a particularly simple manner by producing the mechanical connection to the seat.

The engagement of the plurality of hook elements with the seat cover fastening means can be formed by means of positive locking. The engagement can also, after a predetermined spring force is overcome which is provided, for example, as a result of elastic properties of the hook elements, be formed by means of positive locking or by means of a combination of positive locking and non-positive locking.

The hook elements of the plurality of hook elements are preferably arranged evenly spaced apart from one another, as a result of which a particularly uniform mechanical connection of the fastening device to the seat can be achieved. The plurality of openly formed hook elements particularly preferably includes a plurality of at least three hook elements.

In a further aspect of the disclosure, a seat, in particular a vehicle seat is proposed. The seat has functional components which are formed as a seat base structure for support of a lower part of a seated person or as a backrest structure for support of an upper part of the seated person or as an armrest structure or as a headrest structure. The seat further includes at least one seat cover for at least partial covering of a functional component and at least one seat cover fastening means which is fixedly connected to the at least partially covered functional component. The seat is furthermore equipped with at least one example of an embodiment of the previously disclosed fastening device. The fastening unit of the second holding unit and the at least one seat cover fastening means form a detachably fixed mechanical connection.

The term “detachably fixed mechanical connection” is supposed to be understood in this context as a mechanical connection which can be mounted and detached reversibly by an installer.

The advantages cited in conjunction with the embodiments of the fastening device according to the disclosure also apply fully to the proposed seat.

In one embodiment of the seat, the seat cover fastening means is formed by a plastic wire. Such seat cover fastening means are already known in the field of vehicle seats, as a result of which the fastening device according to the disclosure can advantageously be retrofitted in existing vehicle seats.

A maximum dimension of the base body of the first holding unit in one direction of extent is particularly preferably at least 20% of a dimension, determined in the direction of extent, of the functional component to which the first holding unit is attached.

In this manner, a particularly stable mechanical connection of the holding units and/or a uniform surface pressure on the surface, which faces a seat use, of the seat cover and the opposite opposing surface and/or a particularly concise desired deformation of the surfaces can be achieved.

It will be understood that any described processes or steps within described processes may be combined with other disclosed processes or steps to form structures within the scope of the present invention. The exemplary structures and processes disclosed herein are for illustrative purposes and are not to be construed as limiting.

What is claimed is:

1. A fastening device for fastening at least a part of a seat cover of a seat, comprising:
a first holding unit arranged on a first surface, which faces a seat user, of the seat cover; and
a second holding unit arranged on a counter second surface which is opposite the first surface, wherein the first holding unit has at least one first fastening element and the second holding unit has at least one corresponding second fastening element for mechanical connection of the first and second holding units, and the second holding unit has a fastening unit for mechanical connection to the seat.

2. The fastening device as claimed in claim 1, wherein the mechanical connection between the first holding unit and the second holding unit is formed by adhesive bond with at least one of the first and second fastening elements.

3. The fastening device as claimed in claim 1, wherein the mechanical connection between the first holding unit and the second holding unit is formed by a spring clamp connection between the first and second fastening elements.

4. The fastening device as claimed in claim 1, wherein as a result of the mechanical connection between the first holding unit and the second holding unit, a force is active between the first surface which faces a seat user and the counter second surface, which is opposite the first surface, of the seat cover.

5. The fastening device as claimed in claim 1, wherein the first holding unit has a longitudinally formed first base body and the second holding unit has a longitudinally formed second base body, wherein the first and second base bodies are provided in an installation state for a parallel arrangement on the first surface, which faces a seat user, of the seat cover and the counter-second surface which is opposite the first surface.

6. The fastening device as claimed in claim 5, wherein the fastening unit comprises a plurality of openly formed hook elements which, in an installed state, are arranged on a side, which faces away from the first base body of the first holding unit and the second base body of the second holding unit in a manner spaced apart from one another, and which are provided to arrive at the mechanical connection to the seat in engagement with the fastening device.

7. The fastening device as claimed in claim 1, wherein at least one of the first and second holding units is composed predominantly from a thermoplastic plastic material.

8. A fastening device for fastening a seat cover, comprising:
a first holding unit arranged on an outer surface of the seat cover and having a first fastening element; and
a second holding unit arranged on an inner surface of the seat cover and having a corresponding second fastening element for mechanical connection with the first fastening element, wherein the second holding unit has a fastening unit for mechanical connection to the seat.

9. The fastening device as claimed in claim 8, wherein the mechanical connection between the first holding unit and the second holding unit is formed by adhesive bond with the first and second fastening elements.

10. The fastening device as claimed in claim 8, wherein the mechanical connection between the first holding unit and the second holding unit is formed by a spring clamp connection between the first and second fastening elements.

11. The fastening device as claimed in claim 8, wherein as a result of the mechanical connection between the first holding unit and the second holding unit, a force is active between the outer surface and the inner surface.

12. The fastening device as claimed in claim 8, wherein the first holding unit has a first longitudinally formed base body and the second holding unit has a second longitudinally formed base body, wherein the first and second base bodies are provided in an installation state for a parallel arrangement on the outer surface.

13. The fastening device as claimed in claim 12, wherein the fastening unit comprises a plurality of openly formed hook elements which, in an installed state, are arranged on a side, which faces away from the first base body of the first holding unit and the second base body of the second holding unit in a manner spaced apart from one another, and which are provided to arrive at the mechanical connection to the seat in engagement with a seat cover fastening means of the seat.

14. The fastening device as claimed in claim 8, wherein at least one of the first and second holding units is composed predominantly from a thermoplastic plastic material.

15. A seat comprising:
a seat structure for support of a part of a seated person;
a seat cover for at least partial covering of the seat structure; and
a fastening device for fastening the seat cover on the seat structure and comprising:
a first holding unit arranged on a first surface, which faces a seat user, of the seat cover; and
a second holding unit arranged on a counter second surface which is opposite the first surface, wherein the first holding unit has at least one first fastening element and the second holding unit has at least one corresponding second fastening element for mechanical connection of the first and second holding units, and the second holding unit has a fastening unit for mechanical connection to the seat structure.

16. The seat as claimed in claim 15, wherein a maximum dimension of a base body of the first holding unit in one direction of extent is at least 20% of a dimension, determined in the direction of extent, of the functional component to which the first holding unit is attached.

17. The seat as claimed in claim 15, wherein the fastening device comprises a plastic wire.

18. The seat as claimed in claim 15, wherein the seat structure comprises a backrest structure for support of an upper part of the seated person, and the set cover covers the backrest structure.

19. The seat as claimed in claim 15, wherein the seat structure comprises an armrest structure, and the seat cover covers the armrest structure.

20. The seat as claimed in claim 15, wherein the seat structure comprises a headrest structure and the seat cover covers the headrest structure.
